(19) United States
(12) Patent Application Publication
(10) Pub. No.: US 2026/0055288 A1
(43) Pub. Date: Feb. 26, 2026

(54) Ink Jet Ink Composition And Recording Method

(71) Applicant: SEIKO EPSON CORPORATION, Tokyo (JP)

(72) Inventors: Masahiro YATAKE, Omura (JP); Hiroaki KUMETA, Nagano (JP); Tetsuya AOYAMA, Shiojiri (JP); Kenta KIKUCHI, Suwa (JP)

(21) Appl. No.: 19/308,765

(22) Filed: Aug. 25, 2025

(30) Foreign Application Priority Data
Aug. 26, 2024 (JP) 2024-144506

(51) Int. Cl. C09D 11/326; C09D 11/037

(52) U.S. Cl. CPC C09D 11/326; C09D 11/037

(57) ABSTRACT

An ink jet ink composition includes a vegetable oil-derived carbon black, in which the vegetable oil-derived carbon black has an oxygen content of 0.5 by mass or more, and the ink jet ink composition is an aqueous ink.

The present application is based on, and claims priority from JP Application Serial Number 2024-144506, filed Aug. 26, 2024, the disclosure of which is hereby incorporated by reference herein in its entirety.

### BACKGROUND

### 1. Technical Field

The present disclosure relates to an ink jet ink composition and a recording method.

### 2. Related Art

Ink jet recording methods can record high-definition images with a relatively simple apparatus and have been rapidly developed in various fields. For example, JP-A-2023-128719 discloses, for the purpose of providing an aqueous ink jet ink composition excellent in environmental responsiveness and storage stability, an aqueous ink jet ink composition containing a coloring material of biological origin, a dispersant of biological origin, and an organic solvent of biological origin, in which the organic solvent includes a compound having a hydroxy group and a Hansen solubility parameter of 24.0 (cal/cm³)^{1/2} or more.

As carbon black used as a coloring material of an ink jet ink, carbon black such as plant-derived carbon black, which is environmentally friendly, has been attracting attention. However, there is still room for improvement in storage stability and the like for use as an ink.

### SUMMARY

An ink jet ink composition according to an aspect of the present disclosure contains vegetable oil-derived carbon black, in which the vegetable oil-derived carbon black has an oxygen content of 0.5% by mass or more, and the ink jet ink composition is an aqueous ink.

A recording method according to an aspect of the present disclosure includes depositing an ink using the above-described ink jet ink composition on a recording medium.

### BRIEF DESCRIPTION OF THE DRAWINGS

FIG. 1 is Table 1 showing the compositions of compositions used in Examples and evaluation results thereof.

FIG. 2 is a diagram illustrating an example of a recording apparatus used in a recording method of an embodiment.

### DESCRIPTION OF EMBODIMENTS

An embodiment of the present disclosure (hereinafter, referred to as “the present embodiment”) will be described in detail below with reference to the drawings as necessary, but the present disclosure is not limited thereto, and various modifications can be made without departing from the spirit of the present disclosure. Note that in the drawings, the same elements are denoted by the same reference signs, and redundant descriptions will be omitted. In addition, positional relationships such as up, down, left, and right are based on the positional relationships shown in the drawings unless otherwise specified. Furthermore, the dimensional ratios in the drawings are not limited to the ratios shown in the drawings.

### 1. Ink Jet Ink Composition

The ink jet ink composition according to the present embodiment contains vegetable oil-derived carbon black, in which the vegetable oil-derived carbon black has an oxygen content of 0.5% by mass or more, and the ink jet ink composition is an aqueous ink.

The vegetable oil-derived carbon black is useful as carbon black derived from a natural product which can contribute to reduced carbon dioxide emissions, and has the advantage that the particle diameter thereof can be easily controlled because the same production process as that for petroleum carbon black can be used in view of the point that a liquid raw material (oil) is burned and carbonized. Furthermore, impurities are also easily reduced by refining the liquid raw material (vegetable oil). However, since vegetable oil-derived carbon black includes various functional groups, elements, and the like originating from raw materials, a decrease in dispersion stability and formation of foreign matter are likely to occur, and a problem such as a decrease in storage stability of the ink jet ink composition may occur. Furthermore, there may be concerns about abrasion resistance, color developability, clogging recoverability, stability in ejection and printing, and the like.

Therefore, in the present embodiment, vegetable oil-derived carbon black having an oxygen content of 0.5% by mass or more is used.

Vegetable oil-derived carbon black having a high oxygen content has many oxygen-containing functional groups such as a carboxy group, a phosphorus-containing group, a hydroxy group, and a sulfo group. Examples of the phosphorus-containing group include phosphorus-containing acid groups such as a phosphoric acid group and a phosphonic acid group.

Such an oxygen-containing functional group generally has hydrophilicity, and thus is considered to contribute to improved dispersion stability in water. In addition, it is considered that when a large number of oxygen-containing functional groups are included, the number of hydrophobic non-oxygen-containing functional groups decreases relatively, and it is thus possible to suppress a deterioration in dispersion stability due to the non-oxygen-containing functional groups. In addition, when a large number of oxygen atoms are included, the content of atoms other than oxygen in carbon black also becomes relatively small, and it is inferred that this point also contributes to improved dispersion stability. Therefore, it is considered that the vegetable oil-derived carbon black having a high oxygen content has good dispersion stability and improves the storage stability of the ink jet ink composition.

Further, the vegetable oil-derived carbon black having many oxygen-containing functional groups is prone to react with a calcium salt contained in an absorptive recording medium such as plain paper or a recording medium having an ink absorbing layer, and thus is likely to remain in the vicinity of the surface of the recording medium, and the color developability can be further improved. In addition, the vegetable oil-derived carbon black having a large number of oxygen-containing functional groups has high affinity with a resin, and a dispersant resin or resin particles and a pigment can firmly adhere to each other on a recording medium, and thus excellent abrasion resistance is provided.

Components which can be included in the ink jet ink composition according to the present embodiment and a production method thereof will be described in detail below.

### 1. 1. Pigment

A pigment in the present embodiment contains vegetable oil-derived carbon black having an oxygen content of 0.5% by mass or more. The use of the vegetable oil-derived carbon black can contribute to reduced carbon dioxide emissions. Further, when the oxygen content of the vegetable oil-derived carbon black is a predetermined ratio or more, dispersion stability is improved, and storage stability is excellent. In addition, since the vegetable oil-derived carbon black easily remains on a recording medium, color developability is excellent, and since the affinity with resin is good, abrasion resistance is excellent.

The oxygen content of the vegetable oil-derived carbon black in the present embodiment is preferably 0.5% by mass or more, 1.0% by mass or more, 2.0% by mass or more, or 2.5% by mass or more. In addition, the oxygen content of the vegetable oil-derived carbon black is preferably 4.5% by mass or less, 3.5% by mass or less, or 3.0% by mass or less. When the oxygen content of the vegetable oil-derived carbon black is within the above ranges, storage stability of the ink jet ink composition tends to be further improved.

The oxygen content of carbon black can be determined, for example, using TCH600 from LECO Corporation. To be specific, the oxygen content can be determined by placing a sample together with flux in a graphite crucible, melting and decomposing the sample by resistive heating in an impulse furnace under a helium gas flow, and detecting oxygen as carbon dioxide by a heat conductivity detector and quantifying it.

### 1. 1. 1. Vegetable Oil-Derived Carbon Black

The vegetable oil-derived carbon black in the present embodiment is carbon black obtained by carbonizing a vegetable oil, and is relatively easily produced because the production process thereof is similar to that of petroleum carbon black. Note that the use of the vegetable oil as a mixture in combination with a raw material oil other than vegetable oils, such as petroleum, which is usually used in an oil furnace method or the like, as part of the raw material oil is not excluded, but when the petroleum component increases, a contribution to reduced carbon dioxide emissions decreases.

The method of producing the vegetable oil carbon black in the present embodiment is not particularly limited, and for example, a known method such as a furnace method, a channel method, or a lamp method is used. It is also possible to control the structure and primary particles of carbon black by adding an alkaline agent such as potassium hydroxide or sodium hydroxide in addition to conditions such as the heating temperature and sample amount in the process of preparing a raw material for a vegetable oil or a modified product thereof.

The raw material for the vegetable oil-derived carbon black is not particularly limited, and examples thereof include vegetable seed oils, tall oil, wood tar, and modified products such as hydrogenated products of vegetable seed oils, tall oil, and wood tar and derivatives thereof. The modified products are products obtained by modifying vegetable oils as long as the effect of the present embodiment is obtained. Specific examples thereof include avocado oil, linseed oil, almond oil, fennel oil, perilla oil, olive oil, orange oil, orange roughy oil, cocoa butter, chamomile oil, carrot oil, cucumber oil, apricot kernel oil, kukui nut oil, walnut oil, wheat germ oil, sesame oil, rice oil, rice bran oil, sasanqua oil, safflower oil, salad oil, shea butter, soybean oil, tea oil, evening primrose oil, camellia oil, corn oil, rapeseed oil, persic oil, safflower oil, castor oil, sunflower oil, grape seed oil, hazelnut oil, macadamia nut oil, cottonseed oil, meadowfoam oil, peanut oil, rosehip oil, turtle oil, palm oil, palm kernel oil, Japan wax, coconut oil, wood tar oil, tall oil, and wood-tar creosote, and modified products such as hydrogenated products thereof and derivatives thereof.

The vegetable oil-derived carbon black having an oxygen content of 0.5% by mass or more is preferably surface-treated carbon black. The surface treatment for carbon black is not particularly limited, and examples thereof include a treatment of reacting a compound having an oxygen-containing functional group to introduce the oxygen-containing functional group into carbon black, and a treatment of directly oxidizing a functional group of carbon black using ozone or the like to introduce an oxygen-containing functional group. By using such carbon black, storage stability tends to be further improved.

In addition, oxygen derived from a raw material remains in the vegetable oil-derived carbon black, and thus the oxygen content of the carbon black tends to be higher than that of carbon black using petroleum or the like as a raw material. Therefore, vegetable oil-derived carbon black having a high oxygen content may be obtained by selecting combustion conditions during production and a raw material vegetable oil.

The average particle diameter of the vegetable oil-derived carbon black in the present embodiment is preferably 80 to 350 nm, 90 to 200 nm, or 100 to 150 nm. When the average particle diameter of the vegetable oil-derived carbon black is within the above ranges, the storage stability and color developability of the ink jet ink composition tend to be further improved.

The vegetable oil-derived carbon black is preferably a self-dispersible pigment or a pigment dispersed by a resin (hereinafter, also referred to as a “resin-dispersed pigment”). By using such carbon black, storage stability tends to be further improved.

The self-dispersible pigment is a pigment that can be dispersed in an aqueous medium without a dispersant. Examples of such a self-dispersible pigment include a pigment dispersed in a solvent by introducing a hydrophilic functional group to the pigment surface by performing a physical and/or chemical surface treatment. Examples of the hydrophilic functional group include anionic groups such as a carboxy group, a sulfo group, and a phosphorus-containing acid group. As the self-dispersible pigment, a pigment into which an anionic group is introduced, that is, a pigment having an anionic group, is preferable.

In the case of using a self-dispersible pigment, a fixing resin described later is preferably contained in order to ensure fixability to a recording medium.

The resin-dispersed pigment is a pigment on which a dispersant resin is deposited by adsorption, adhesion, coating, or the like and which is dispersed in a solvent. The resin-dispersed pigment can be prepared by, for example, a method in which a dispersant resin and a pigment are stirred in water to disperse the pigment, or a method in which a dispersant resin and a pigment are stirred in an organic solvent or the like and then subjected to phase inversion emulsification in an aqueous layer. When a resin-dispersed pigment is used as the vegetable oil-derived carbon black, abrasion resistance tends to be improved without using a fixing resin. Even when a resin-dispersed pigment is used, a fixing resin may be used.

The dispersant resin is not particularly limited, and any known resin that can be used in an ink jet ink can be used. For example, a dispersant resin made from a hydrophilic monomer such as (meth)acrylic acid or a salt thereof can be used.

The content of the vegetable oil-derived carbon black is preferably 0.1% to 15% by mass, 1.0% to 10% by mass, 1.5% to 8.0% by mass, or 2.0% to 6.0% by mass with respect to the total amount of the ink jet ink composition. When the content of the vegetable oil-derived carbon black falls within the above ranges, intermittent ejection stability and continuous printing stability tend to be further improved.

### 1. 2. Organic Solvent

The ink jet ink composition according to the present embodiment may contain an organic solvent. By including the organic solvent, intermittent ejection stability of the ink jet ink composition tends to be further improved, and it is possible to effectively suppress evaporation of moisture from a recording head during long-term standing.

Examples of the organic solvent include water-soluble organic solvents such as polyols and glycol ethers. One kind of organic solvent may be used alone, or two or more kinds thereof may be used in combination.

Examples of the polyols include ethylene glycol, propylene glycol, 1,2-propanediol, 1,2-butanediol, 1,2-pentanediol, 1,2-hexanediol, 1,2-octanediol, 1,3-propanediol, 1,4-butanediol, 1,6-hexanediol, diethylene glycol, triethylene glycol, propylene glycol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, and glycerin.

Among the polyols, an alkanediol having 5 or more carbon atoms is preferable because the permeability of the ink into a recording medium is further improved. In particular, an alkanediol having 6 to 10 carbon atoms is preferable, and an alkanediol having 6 to 8 carbon atoms is more preferable. In particular, a 1,2-alkanediol is particularly preferred.

In addition, among the polyols, an alkanediol having 4 or less carbon atoms, or a glycol having a structure in which hydroxy groups of molecules of alkanediols having 4 or less carbon atoms are condensed is preferable, and the moisture retaining properties of the ink tend to be further improved. In particular, an alkanediol having 3 or less carbon atoms, or a glycol having a structure in which hydroxy groups of molecules of alkanediols having 3 or less carbon atoms are condensed is preferable, and an alkanediol having 2 carbon atoms, or a glycol having a structure in which hydroxy groups of molecules of alkanediols having 2 carbon atoms are condensed is more preferable.

The glycol ethers may be a monoether or diether of an alkylene glycol, and an alkyl ether is preferable. Specific examples thereof include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, and tripropylene glycol monobutyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

The normal boiling point of the organic solvent is preferably 160° C. or higher, more preferably 170° C. to 300° C., 180° C. to 250° C., or 200° C. to 230° C.

The content of the organic solvent is preferably 3% to 50% by mass, 5% to 40% by mass, 10% to 30% by mass, 15% to 25% by mass, or 17% to 22% by mass with respect to the total amount of the ink jet ink composition. When the content of the organic solvent is within the above ranges, intermittent ejection stability tends to be further improved.

### 1. 3. Surfactant

The ink jet ink composition according to the present embodiment may include a surfactant. By including the surfactant, intermittent ejection stability, continuous printing stability, and clogging recoverability tend to be further improved.

The surfactant is not particularly limited, and examples thereof include a silicone-based surfactant, an acetylene glycol-based surfactant, and a fluorine-based surfactant. One kind of surfactant may be used alone, or two or more kinds thereof may be used in combination.

Among these, it is preferable to include any one of the silicone-based surfactant and the acetylene glycol-based surfactant. By using such a surfactant, intermittent ejection stability, continuous printing stability, and clogging recoverability tend to be further improved.

Examples of the silicone-based surfactant include a polysiloxane-based compound and a polyether-modified organosiloxane. Commercially available products of such a silicone-based surfactant are not particularly limited, and examples thereof include SILFACE SAG503A (manufactured by Nissin Chemical Industry Co., Ltd.).

The acetylene glycol-based surfactant is not particularly limited, and examples thereof include one or more selected from alkylene oxide adducts of 2,4,7,9-tetramethyl-5-decyne-4,7-diol and 2,4,7,9-tetramethyl-5-decyne-4,7-diol, and alkylene oxide adducts of 2,4-dimethyl-5-decyn-4-ol and 2,4-dimethyl-5-decyn-4-ol. Commercially available products of such an acetylene glycol-based surfactant are not particularly limited, and examples thereof include SURFYNOL 104PG50 (manufactured by Nissin Chemical Industries, Ltd.).

The content of the surfactant is preferably 0.05% to 5% by mass, 0.1% to 2% by mass, 0.2% to 1.5% by mass, or 0.7% to 1.2% by mass with respect to the total amount of the ink jet ink composition. When the content of the surfactant is within the above ranges, intermittent ejection stability and continuous printing stability tend to be further improved.

### 1. 4. Fixing Resin

The ink jet ink composition according to the present embodiment may include a fixing resin. The fixing resin in the present embodiment is a resin for enhancing adhesiveness of an ink component to a recording medium, and is distinguished from the dispersant resin.

The fixing resin may be a water-soluble resin or resin particles. Among these, resin particles are preferable. By using such a fixing resin, abrasion resistance tends to be further improved. The resin particles may be supplied in an emulsion form or may be supplied as powder.

As the fixing resin, an acrylic resin such as polyacrylic acid, an acrylic acid-acrylonitrile copolymer, a vinyl acetate-acrylic acid copolymer, a vinyl acetate-acrylic acid ester copolymer, a styrene-acrylic acid copolymer, a styrene-methacrylic acid copolymer, a styrene-acrylic acid-alkyl acrylate copolymer, a styrene-methacrylic acid-alkyl acrylate copolymer, a styrene-α-methylstyrene-acrylic acid copolymer, a styrene-α-methylstyrene-acrylic acid-alkyl acrylate copolymer, or a styrene-vinyl acetate-acrylic acid copolymer; a urethane-based resin which is a resin containing a urethane bond formed by a reaction between an isocyanate group and a hydroxy group; or a polyester-based resin, a polyether-based resin, a polyolefin-based resin, or a natural resin such as glue, gelatin, or saponin can be used.

Among them, the fixing resin is preferably a urethane-based resin or an acrylic resin. Since the urethane-based resin has high affinity with the vegetable oil-derived carbon black having a high oxygen content, abrasion resistance tends to be further improved. On the other hand, when the acrylic resin is used, clogging recoverability tends to be further improved.

Among these, it is particularly preferable to include any one of a (meth)acrylic acid-based polymer and a styrene-(meth)acrylic acid-based polymer. By using such a fixing resin, abrasion resistance tends to be further improved. Among (meth)acrylic acid-based polymers, polymers of monomers in which at least one of an alkyl (meth)acrylate having 1 to 24 carbon atoms and a cyclic alkyl (meth)acrylate having 3 to 24 carbon atoms accounts for 70% by mass or more are more preferable. Specific examples thereof include methyl (meth)acrylate, ethyl (meth)acrylate, propyl (meth)acrylate, n-butyl (meth)acrylate, isobutyl (meth)acrylate, pentyl (meth)acrylate, hexyl (meth)acrylate, 2-ethylhexyl (meth)acrylate, octyl (meth)acrylate, nonyl (meth)acrylate, decyl (meth)acrylate, t-butylcyclohexyl (meth)acrylate, lauryl (meth)acrylate, isobornyl (meth)acrylate, cetyl (meth)acrylate, stearyl (meth)acrylate, isostearyl (meth)acrylate, tetramethylpiperidyl (meth)acrylate, dicyclopentanyl (meth)acrylate, dicyclopentenyl (meth)acrylate, dicyclopentenyloxy (meth)acrylate, and behenyl (meth)acrylate. In addition, as monomers other than those described above, for example, hydroxy (meth)acrylates having a hydroxy group such as hydroxyethyl (meth)acrylate, hydroxypropyl (meth)acrylate, and diethylene glycol (meth)acrylate, urethane (meth)acrylates, and epoxy (meth)acrylates can also be used.

As the fixing resin, a commercially available product may be used, and examples thereof include a urethane-based resin such as AP201 (manufactured by DIC Corporation) and an acrylic resin such as VINYBLAN 2687 (manufactured by Nissin Chemical Industry Co., Ltd.).

The content of the fixing resin is preferably 0.1% to 10% by mass, 1.2% to 6.0% by mass, 2.0% to 4.0% by mass, or 2.5% to 3.5% by mass with respect to the total amount of the ink jet ink composition. By setting the content of the fixing resin within the above ranges, abrasion resistance tends to be further improved. In addition, clogging recoverability and stability of ejection and printing also tend to be further improved.

### 1. 5. pH Adjuster

The ink jet ink composition in the present embodiment may contain a pH adjuster, as necessary. Examples of the pH adjuster include inorganic acids (for example, sulfuric acid, hydrochloric acid, nitric acid, and the like), inorganic bases (for example, lithium hydroxide, sodium hydroxide, potassium hydroxide, ammonia, and the like), organic acids (for example, adipic acid, citric acid, succinic acid, and the like), and organic bases (for example, triethanolamine, diethanolamine, monoethanolamine, triisopropanolamine, diisopropanolamine, trishydroxymethylaminomethane, and the like). One kind of pH adjuster may be used alone, or two or more kinds thereof may be used in combination.

The content of the pH adjuster is preferably 0% to 5% by mass, 0.01% to 3% by mass, 0.03% to 1% by mass, or 0.05% to 0.5% by mass with respect to the total amount of the ink jet ink composition. When the content of the pH adjuster is within the above ranges, storage stability, intermittent ejection stability, and continuous printing stability tend to be further improved.

### 1. 6. Chelating Agent

The ink jet ink composition in the present embodiment preferably includes a chelating agent. When the ink jet ink composition includes the chelating agent, it is possible to prevent the pigment component or the resin component from aggregating or deteriorating due to a polyvalent metal salt contained as an impurity, and thus storage stability tends to be further improved. Since the vegetable oil-derived carbon black contains a large amount of impurities derived from raw materials, the effect of including the chelating agent is more remarkable.

The chelating agent is not particularly limited, and examples thereof include ethylenediaminetetraacetic acid and salts thereof, hexametaphosphoric acid and salts thereof, pyrophosphoric acid and salts thereof, metaphosphoric acid and salts thereof, methylglycinediacetic acid and salts thereof, L-glutaminediacetic acid and salts thereof, L-aspartic acid-diacetic acid and salts thereof, diethylenetriaminepentaacetic acid and salts thereof, gluconic acid and salts thereof, citric acid and salts thereof, nitrilo-3-propionic acid and salts thereof, nitrilotrisphosphonic acid and salts thereof, dihydroxyethylglycine and salts thereof, hydroxyethyliminodiacetic acid and salts thereof, 1,3-diamino-2-hydroxypropanetetraacetic acid and salts thereof, hydroxyethylidenediphosphonic acid and salts thereof, nitrilotrimethylenephosphonic acid and salts thereof, and phosphonobutanetricarboxylic acid and salts thereof.

The content of the chelating agent is preferably 0% to 3% by mass, 0.01% to 0.5% by mass, 0.03% to 0.3% by mass, or 0.05% to 0.12% by mass with respect to the total amount of the ink jet ink composition. When the content of the chelating agent is within the above ranges, storage stability, intermittent ejection stability, and continuous printing stability tend to be further improved.

### 1. 7. Water

The ink jet ink composition of the present embodiment is an aqueous ink. The aqueous ink is an ink including at least water as a solvent component contained in the ink.

The content of water is preferably 40% to 99% by mass, 45% to 98% by mass, 50% to 98% by mass, 55% to 98% by mass, 60% to 98% by mass, 65% to 95% by mass, or 70% to 85% by mass with respect to the total amount of the ink. When the content of water is within the above ranges, storage stability and ejection stability tend to be excellent.

### 1. 8. Other Components

The ink jet ink composition may include components other than the above-described components. As the other components, various additives such as a dissolution aid, a viscosity modifier, an antioxidant, a preservative, a fungicide, and a corrosion inhibitor can be added as appropriate.

### 2. Ink Jet Recording Method

An ink jet recording method according to the present embodiment includes a step of, using a predetermined ink jet head, ejecting the ink jet ink composition from the ink jet head to deposit the ink jet ink composition on a recording medium.

### 3. Ink Jet Recording Apparatus

An ink jet recording apparatus of the present embodiment includes the ink composition described above and an ink jet head having a nozzle that ejects the ink composition described above onto a recording medium, and preferably further includes a supply flow path through which the ink composition described above flows and which is connected to the ink jet head, and a filter unit provided in the supply flow path of the ink jet head.

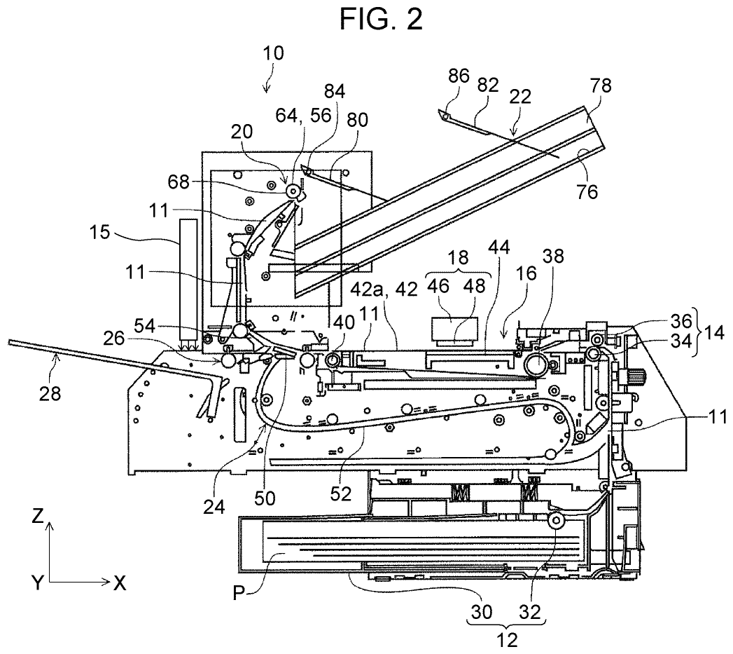

FIG. 2 illustrates an example of the ink jet recording apparatus that can be used in the present embodiment. The ink jet recording apparatus according to the present embodiment will be described in more detail with reference to FIG. 2. In an X-Y-Z coordinate system illustrated in FIG. 3, the X direction indicates a length direction of a recording medium, the Y direction indicates a width direction of the recording medium in a transport path in the recording apparatus, and the Z direction indicates an apparatus height direction.

A recording apparatus 10 is, as an example, a line type ink jet printer capable of performing high-speed and high-density printing. The recording apparatus 10 includes a feeding section 12 storing a recording medium P such as paper, a transport section 14, a belt transport section 16, a recording section 8, a face-down (Fd) discharge section 20 as “discharge section,” a face-down (Fd) placement section 22 as “placement section,” an inversion path section 24 as “inversion transport mechanism,” a face-up (Fu) discharge section 26, and a face-up (Fu) placement section 28.

The feeding section 12 is disposed in a lower portion of the recording apparatus 10. The feeding section 12 includes a feeding tray 30 storing the recording medium P and a feeding roller 32 that feeds the recording medium P stored in the feeding tray 30 to the transport path 11.

The recording medium P stored in the feeding tray 30 is fed to the transport section 14 along the transport path 11 by the feeding roller 32. The transport section 14 includes a transport driving roller 34 and a transport driven roller 36. The transport driving roller 34 is rotationally driven by a drive source (not shown). In the transport section 14, the recording medium P is nipped between the transport driving roller 34 and the transport driven roller 36 and transported to the belt transport section 16 positioned on the downstream side in the transport path 11.

The belt transport section 16 includes a first roller 38 positioned on the upstream side in the transport path 11, a second roller 40 positioned on the downstream side, an endless belt 42 mounted on the first roller 38 and the second roller 40 in a rotationally movable manner, and a support 44 supporting an upper section 42a of the endless belt 42 between the first roller 38 and the second roller 40.

The endless belt 42 is driven to move from the +X direction to the −X direction in the upper section 42a by the first roller 38 or the second roller 40 driven by a drive source (not shown). Therefore, the recording medium P transported from the transport section 14 is further transported to the downstream side in the transport path 11 in the belt transport section 16.

The recording section 8 includes a line type ink jet head 48 and a head holder 46 holding the ink jet head 48. The recording section 8 may be of a serial type, in which an ink jet head is provided on a carriage that reciprocates in the Y-axis direction. The ink jet head 48 is disposed so as to face the upper section 42a of the endless belt 42 supported by the support 44. When the recording medium P is transported in the upper section 42a of the endless belt 42, the ink jet head 48 ejects ink toward the recording medium P to execute recording. The recording medium P is transported to the downstream side of the transport path 11 by the belt transport section 16 while recording is performed thereon.

A first branch section 50 is provided on the downstream side of the transport path 11 of the belt transport section 16. The first branch section 50 is configured to be switchable between the transport path 11 for transporting the recording medium P to the Fd discharge section 20 or the Fu discharge section 26 and an inversion path 52 of the inversion path section 24 for inverting a recording surface of the recording medium P and transporting the recording medium P again to the recording section 8. The recording surface of the recording medium P, which is switched to the inversion path 52 by the first branch section 50 and is transported, is inverted in a transport process in the inversion path 52, and the recording medium P is transported again to the recording section 8 such that the surface opposite to the initial recording surface faces the ink jet head 48.

A second branch section 54 is further provided on the downstream side of the first branch section 50 along the transport path 11. The second branch section 54 is configured to be capable of switching the transport direction of the recording medium P so as to transport the recording medium P toward the Fd discharge section 20 or transport the recording medium P toward the Fu discharge section 26.

The recording medium P transported toward the Fd discharge section 20 in the second branch section 54 is discharged from the Fd discharge section 20 and placed on the Fd placement section 22. At this time, the recording medium P is placed such that the recording surface thereof faces the Fd placement section 22. Further, the recording medium P transported toward the Fu discharge section 26 in the second branch section 54 is discharged from the Fu discharge section 26 and placed on the Fu placement section 28. At this time, the recording medium P is placed such that the recording surface thereof faces the opposite side from the Fu placement section 28.

### 4. Recording Medium

The recording medium used in the present embodiment is not particularly limited, and examples thereof include an absorptive recording medium, a low-absorptive recording medium, and a non-absorptive recording medium, and the absorbent recording medium is preferable.

Examples of the absorptive recording medium include plain paper such as electrophotographic paper having high ink permeability, and ink jet paper (ink jet dedicated paper including an ink absorbing layer formed of silica particles or alumina particles or an ink absorbing layer formed of a hydrophilic polymer such as polyvinyl alcohol (PVA) or polyvinylpyrrolidone (PVP)).

Examples of the low-absorptive recording medium include art paper, coated paper, and cast paper, which have relatively low ink permeability and are used for general offset printing.

Examples of the non-absorptive recording medium include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates and plastic films coated by evaporation of these various metals, and plates of alloys such as stainless steel and brass; and recording media in which a film of plastic such as polyvinyl chloride, polyethylene, polypropylene, polyethylene terephthalate (PET), polycarbonate, polystyrene, or polyurethane is bonded (applied) onto a paper substrate.

### 5. Recorded Matter

Recorded matter of the present embodiment is obtained by depositing the ink composition described above on a recording medium. The recorded matter of the present embodiment using the ink composition described above can be recorded with an ink having excellent storage stability and ejection stability. In addition, by using the ink composition including the carbon black derived from biomass or the carbon black derived from recycled raw materials, it is possible to perform recording with an ink having excellent storage stability and ejection stability while considering the environment.

### EXAMPLES

The present disclosure will be more specifically described with reference to Examples and Comparative Examples below. The present disclosure is not limited by the following Examples in any way.

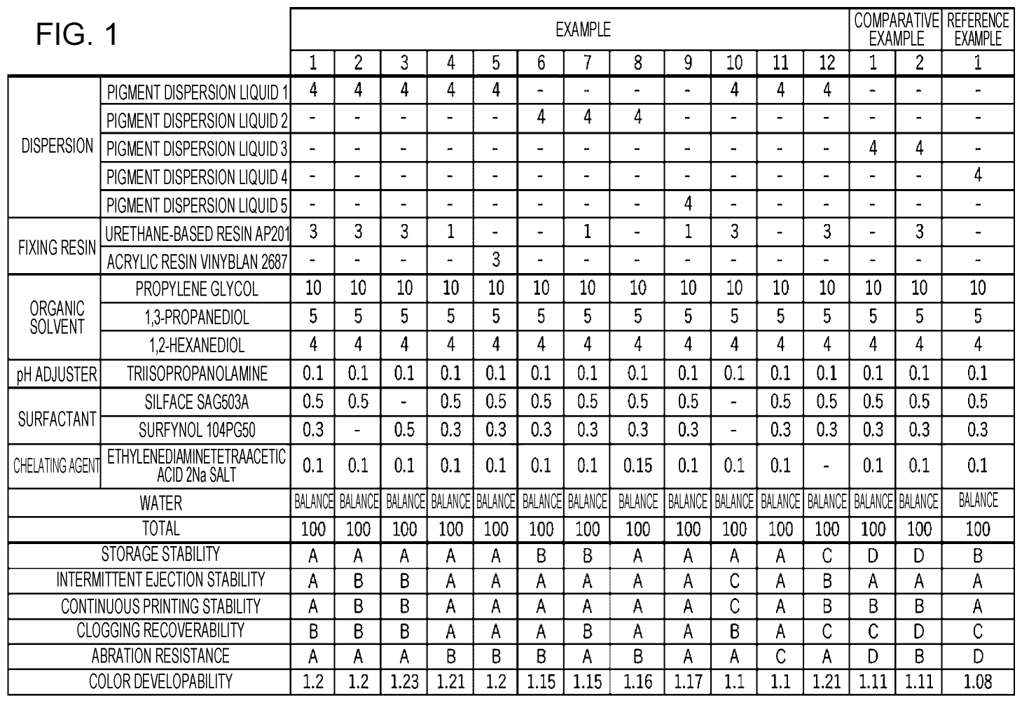

FIG. 1 shows Table 1 showing the compositions of ink compositions of Examples and Comparative Examples and evaluation results thereof.

### 1. Preparation of Ink Jet Ink Composition

Components are mixed so as to have the compositions shown in Table 1, sufficiently stirred, and then subjected to filtration under reduced pressure with a microfilter (manufactured by Millipore Corporation) having a pore size of 5.0 μm, thereby obtaining an ink jet ink composition of each example. Numerical values of the components shown in each example in the table represent mass % unless otherwise described. In addition, in the table, each numerical value represents mass % of the solid content of the component.

Details of the product components used in Table 1 are as follows.
Pigment dispersion liquid
Pigment dispersion liquids 1 to 5
Fixing resin
Urethane-based resin AP201 (manufactured by DIC Corporation)
Acrylic resin VINYBLAN 2687 (manufactured by Nissin Chemical Industry Co., Ltd.)
Organic solvent
Propylene glycol
1,3-Propanediol
1,2-Hexanediol
Surfactant
SILFACE SAG503A (silicone-based surfactant, manufactured by Nissin Chemical Industry Co., Ltd.)
SURFYNOL 104PG50 and the like (acetylene glycol-based surfactant, manufactured by Nissin Chemical Industries, Ltd.)
pH adjuster
Triisopropanolamine
Chelating agent
Ethylenediaminetetraacetic acid 2Na salt
Water
Ion-exchanged water
Preparation Example of pigment dispersion liquid

### Pigment Dispersion Liquid 1

Preliminarily moistened carbon black is obtained by mixing 500 g of ion-exchanged water and 150 g of vegetable oil-derived carbon black (Printex Nature, manufactured by Oriont Engineered Carbons S.A.), and stirring the mixture for 30 minutes using a rocking mill with 1 mm zirconia beads. Then, 4485 g of ion-exchanged water is added, and the carbon black is dispersed by passing the carbon black through LABSTAR Mini LMZ015 (manufactured by Ashizawa Finetech Ltd.) five times. The average particle size of the pigment at this time is 110 nm. The obtained dispersion liquid is transferred to a high-pressure vessel and pressurized with a pressure of 3 MPa, and ozone water having an ozone concentration of 100 ppm is then introduced to subject the surface of the carbon black to a surface treatment through ozone oxidation. The pH value of the dispersion liquid is then adjusted to 9.0 using a 0.1 mol/L aqueous sodium hydroxide solution, and the concentration of the pigment solid content is subsequently adjusted to obtain a pigment dispersion liquid 1. The pigment dispersion liquid 1 includes carbon black that is a self-dispersible pigment in which a —COONa group is bonded to particle surfaces, the content of the carbon black is 15% by mass, and the oxygen content of the carbon black is 2.7% by mass after the surface treatment described above.

### Pigment Dispersion Liquid 2

A mixture liquid is obtained by mixing 500 g of vegetable oil-derived carbon black (Printex Nature, manufactured by Oriont Engineered Carbons S.A.) having an oxygen content of 2.2% by mass with 1000 g of a resin dispersant (Solsperse J400, manufactured by The Lubrizol Corporation) and 14000 g of water. The mixture liquid is dispersed by passing the mixture liquid through LABSTAR Mini LMZ015 (manufactured by Ashizawa Finetech Ltd.), which is a bead mill using 0.2 mm zirconia beads, ten times, impurities are then removed by centrifugation, and filtration under reduced pressure is further performed using a microfilter (manufactured by Millipore Corporation) having a pore size of 5.0 μm. The concentration of the pigment solid content is adjusted to obtain a pigment dispersion liquid 2 having a pH value of 9.0. The pigment dispersion liquid 2 includes carbon black dispersed by a resin dispersant. The carbon black content is 15.0% by mass, the resin content is 7.5% by mass, and the oxygen content of the carbon black is 2.2% by mass.

### Pigment Dispersion Liquid 3

A pigment dispersion liquid 3 is obtained in the same manner as the pigment dispersion liquid 2 except that Printex Nature (manufactured by Oriont Engineered Carbons S.A.) is used after the oxygen content is reduced to 0.45% by mass by heating in a reducing atmosphere. The oxygen content of the carbon black is 0.45% by mass.

### Pigment Dispersion Liquid 4

A pigment dispersion liquid 4 is obtained in the same manner as the pigment dispersion liquid 2 except that Printex Nature (manufactured by Oriont Engineered Carbons S.A.) is changed to petroleum-derived carbon black MA100 (manufactured by Mitsubishi Chemical Corporation) having an oxygen content of 0.3% by mass in the pigment dispersion liquid 2. The oxygen content of the carbon black is 0.3% by mass.

### Pigment Dispersion Liquid 5

A pigment dispersion liquid 5 is obtained in the same manner as the pigment dispersion liquid 1 except that ozone water having an ozone concentration of 150 ppm is used as the ozone water in the pigment dispersion liquid 1. The oxygen content of the carbon black is 3.2% by mass.

### 2. Evaluation Method

### 2. 1. Storage Stability

Into a 30 mL sample bottle is put 20 g of each of the ink jet ink compositions, and the storage stability is evaluated from the change in viscosity with respect to the initial viscosity after the ink jet ink composition is left to stand at 70° C. for 7 days.

### Evaluation Criteria

A: Viscosity change is less than 1%
B: Viscosity change is 1% or more and less than 5%
C: Viscosity change is 5% or more and less than 10%
D: Viscosity change is 10% or more

### 2. 2. Intermittent Ejection Stability

A modified PX-S270T printer (manufactured by Seiko Epson Corporation) is used to evaluate the ejection stability during intermittent printing in an environment at a temperature of 40° C. and a relative humidity of 20%. First, it is confirmed that the ink jet ink composition is normally ejected from all nozzles. Then, after the ink jet ink composition is ejected onto A4 size super fine paper (manufactured by Seiko Epson Corporation), a downtime of 2 minutes is provided, and the ink jet ink composition is ejected again onto A4 size photo paper. In the second ejection, the positional deviation between the position of the dot of the first droplet deposited on the A4 size photo paper and the target position is measured with an optical microscope. Based on the obtained positional deviation of the dot, the intermittent characteristic is evaluated by the following evaluation criteria.

### Evaluation Criteria

A: Positional deviation of dot is 10 μm or less
B: Positional deviation of dot is more than 10 μm and 20 μm or less
C: Positional deviation of dot is more than 20 μm and 30 μm or less
D: Positional deviation of dot is more than 30 μm

### 2. 3. Continuous Printing Stability

An ink cartridge of a PX-S270T printer (manufactured by Seiko Epson Corporation) is filled with the ink jet ink composition obtained as described above. Then, a print sample with a print duty of 5% is continuously printed on A4 size super fine special paper (manufactured by Seiko Epson Corporation) at a resolution of 720 dpi (vertical)×720 dpi (horizontal) in an environment at a temperature of 40° C. and a humidity of 20% for up to 8 hours, and the time until ejection failure or ejection disturbance is observed is measured.

### Evaluation Criteria

A: No ejection failure or ejection disturbance is observed even after 8 hours from the start of ejection.
B: Ejection failure or ejection disturbance is observed in 2 hours or more and less than 8 hours from the start of ejection.
C: Ejection failure or ejection disturbance is observed in 1 hour or more and less than 2 hours from the start of ejection.
D: Ejection failure, ejection disturbance, or the like is observed in less than one hour from the start of ejection.

### 2. 4. Clogging Recoverability

Using a PX-S270T printer (manufactured by Seiko Epson Corporation), an ink cartridge of this printer is filled with the ink jet ink composition obtained as described above, printing is performed on A4 size super fine special paper (manufactured by Seiko Epson Corporation) at a resolution of 720 dpi (vertical)×720 dpi (horizontal), and it is confirmed that the ink jet ink composition is ejected from all nozzles. Thereafter, the printer is left to stand in an environment at a temperature of 40° C. and a relative humidity of 20% for 30 days. After the standing, the ink composition is ejected again from all the nozzles, cleaning is repeatedly performed until printing equivalent to the initial printing becomes possible, and the number of times of cleaning at that time is counted. Based on the number of times of cleaning, the clogging recoverability is evaluated according to the following evaluation criteria.

### Evaluation Criteria

A: Ink composition is ejected from all nozzles after cleaning once or twice.
B: Ink composition is ejected from all nozzles after cleaning 3 to 5 times.
C: Ink composition is ejected from all nozzles after cleaning more than 5 times.
D: Ink composition cannot be ejected from one or more of nozzles after cleaning.

### 2. 5. Abrasion Resistance

The abrasion resistance is evaluated using an AB-301 Gakushin-type abrasion resistance evaluation apparatus (manufactured by TESTER SANGYO CO., LTD.) under conditions of a load of 200 g and 100 reciprocations in accordance with JIS L0849 2013. Using a PX-S270T printer (manufactured by Seiko Epson Corporation), a solid image of 1.0 inches×0.5 inches having a recording duty of 100% is recorded on a film (OPP plain roll 25 μm thick, manufactured by TOYOBO CO., LTD.) to obtain printed matter. Subsequently, printing is performed at 40° C. with a dot density of 1440 dpi×1440 dpi using PX-G930 modified so that the platen temperature can be raised. After printing, the printed matter is heated at 50° C. for 1 minute, and one day after the printing, a dry cotton shirting fabric (dry friction property) is pressed on the solid image of the printed matter to perform evaluation. Thereafter, the staining of the cotton shirting fabric, the staining of a non-recorded portion, and a peeling degree of the printed portion are visually checked, and the abrasion resistance is evaluated according to the following evaluation criteria. In the present examples, the recording duty of a solid image recorded under the conditions in which one ink droplet having a mass of 28 ng±10% per droplet is applied to a unit area of 1/600 inches× 1/600 inches is defined as 100%.

### Evaluation Criteria

A: There is almost no staining of cotton shirting fabric and no staining of non-recorded portion, and there is almost no peeling of printed portion.
B: There are little staining of cotton shirting fabric and little staining of non-recorded portion, and there is almost no peeling of printed portion.
C: There are staining of cotton shirting fabric and staining of non-recorded portion, and a small degree of peeling is observed in printed portion.
D: There are considerable staining of cotton shirting fabric and considerable staining of non-recorded portion, and a large degree of peeling is observed in printed portion.

### 2. 6. Color Developability

Using a PX-S270T printer (manufactured by Seiko Epson Corporation), an ink cartridge of this printer is filled with the ink, and printing is performed on A4 size Xerox P paper (manufactured by FUJIFILM Business Innovation Corp.) at a resolution of 720 dpi (vertical)×720 dpi (horizontal). After printing, the optical density (hereinafter, also referred to as “OD”) of the printed matter was measured by measuring the mean value at 10 points using an il Pro2 spectrophotometer manufactured by X-Rite, Incorporated. Evaluation criteria
A: OD is 1.0 or more
B: OD is 0.8 or more and less than 1.0
C: OD is 0.6 or more and less than 0.8
D: OD is less than 0.6

### 3. Evaluation Result

Table 1 shows the compositions of the ink jet ink compositions used in the examples and the evaluation results. As can be seen from Table 1, all of the ink jet ink compositions of Examples, which are each an aqueous ink containing vegetable oil-derived carbon black and in which the oxygen content of the vegetable oil-derived carbon black is 0.5% by mass or more, have excellent storage stability. Furthermore, the intermittent ejection stability, the continuous printing stability, the clogging recoverability, the abrasion resistance, and the color developability are also good. On the other hand, Comparative Examples, which do not satisfy the above conditions, are both inferior in storage stability. Further, in Reference Example containing petroleum-derived carbon black, the oxygen content of the carbon black is less than 0.5% by mass, but the storage stability is not inferior. From these results, it is found that a problem of storage stability arises in the case of vegetable oil-derived carbon black.

What is claimed is:

1. An ink jet ink composition, comprising:
vegetable oil-derived carbon black, wherein
the vegetable oil-derived carbon black has an oxygen content of 0.58 by mass or more, and
the ink jet ink composition is an aqueous ink.

2. The ink jet ink composition according to claim 1, wherein
the oxygen content of the vegetable oil-derived carbon black is 2.5% by mass or more.

3. The ink jet ink composition according to claim 1, wherein
the vegetable oil-derived carbon black includes surface-treated carbon black.

4. The ink jet ink composition according to claim 1, wherein
the vegetable oil-derived carbon black is a self-dispersible pigment or a resin-dispersed pigment dispersed by a resin.

5. The ink jet ink composition according to claim 1, further comprising:
a fixing resin.

6. The ink jet ink composition according to claim 5, wherein
the fixing resin is resin particles.

7. The ink jet ink composition according to claim 5, wherein
the fixing resin is a urethane-based resin or an acrylic resin.

8. The ink jet ink composition according to claim 1, further comprising:
a chelating agent.

9. The ink jet ink composition according to claim 1, further comprising:
a silicone-based surfactant or an acetylene glycol-based surfactant.

10. The ink jet ink composition according to claim 1, further comprising:
an organic solvent.

11. The ink jet ink composition according to claim 1, wherein
the vegetable oil-derived carbon black has an anionic group.

12. A recording method, comprising:
ejecting the ink jet ink composition according to claim 1 from an ink jet head to deposit the ink jet ink composition on a recording medium.
